(19) United States
(12) Patent Application Publication
(10) Pub. No.: US 2008/0016543 A1
(43) Pub. Date: Jan. 17, 2008

(54) Method of controlling data broadcast application and broadcast receiver receiving the same

(76) Inventor: Jin Wook Kwon, Seoul (KR)

Correspondence Address: Song K. Jung;MCKENNA LONG & ALDRIDGE LLP, 1900 K Street, N.W., Washington, DC, 20006, US

(21) Appl. No.: 11/826,344

(22) Filed: Jul. 13, 2007

(30) Foreign Application Priority Data
Jul. 14, 2006 (KR) 10-2006-0066147

(51) Int. Cl. H04N 7/173; H04N 7/16

(52) U.S. Cl. 725/132; 725/140; 725/152

(57) ABSTRACT

A method of controlling a data broadcast application and broadcast receiver processing the same are disclosed. According to one general implementation, a method of processing a data broadcast signal, which is supported by a data broadcasting platform, includes receiving an application information table supported by a data broadcasting platform, extracting an application upgrade information by parsing the application information table, tuning a channel carrying upgrade data according to the extracted application upgrade information and executing an application upgrade by receiving the upgrade data via the tuned channel.

This application claims the benefit of the Korean Patent Application No. 10-2006-0066147, filed on Jul. 14, 2006, which is hereby incorporated by reference as if fully set forth herein.

### BACKGROUND OF THE INVENTION

1. Field of the Invention

The present disclosure relates to a method of controlling a data broadcast and broadcast receiver receiving the same, and more particularly, to a method of controlling a data broadcast application and broadcast receiver processing the same.

2. Discussion of the Related Art

Generally, a broadcasting station or the like transmits video and audio signals. Owing to the rapid developments of digital broadcasting, the broadcasting station or the like recently transmits various data broadcast signals independently or together with video and audio signals.

There are various kinds of data broadcasting such as OCAP (Open Cable Application Platform) data broadcasting, MHP (Multimedia Home Platform) data broadcasting, ACAP (Advanced Common Application Platform) data broadcasting, and the like for example.

In transmitting data broadcasting, a cable system operator (SO) or a multiple system operator (MSO) provides a broadcast receiver with a bound application, an unbound application, and the like.

In particular, the broadcast receiver receives a data broadcast application and then upgrades the received data broadcast application.

In this case, the related method of controlling a data broadcast application and broadcast receiver processing the same however has the following problems or disadvantages.

First of all, while a specific channel is viewed, if upgrade data is received via a channel different from the specific channel, the current data broadcasting platform fails to propose a process for upgrading the received data.

Secondly, while a specific channel is viewed, if upgrade data is transmitted on a channel different from the specific channel, the current data broadcasting platform fails to propose a process for processing a currently viewed image in the course of performing an upgrade.

### SUMMARY OF THE INVENTION

Accordingly, the present invention is directed to a method of controlling a data broadcast application and broadcast receiver processing the same that substantially obviate one or more problems due to limitations and disadvantages of the related art.

An object of the present invention is to provide a method of controlling a data broadcast application and broadcast receiver processing the same, by which an application can be smoothly upgraded by controlling channel tuning while upgrade data is transmitted on a channel different from a currently viewed channel.

Another object of the present invention is to provide a method of controlling a data broadcast application and broadcast receiver processing the same, by which an application can be upgraded without interrupting to display a currently viewed channel in case of using a plurality of tuners.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

According to one general implementation, a method of processing a data broadcast signal, which is supported by a data broadcasting platform, includes receiving an application information table supported by a data broadcasting platform, extracting an application upgrade information by parsing the application information table, tuning a channel carrying upgrade data according to the extracted application upgrade information and executing an application upgrade by receiving the upgrade data via the tuned channel.

According to other general implementation, an apparatus for receiving a data broadcast signal, which is supported by a data broadcasting platform, includes a signal receiving unit receiving and tuning a channel including an application supported by a data broadcasting platform and an application information table, a data decoder decoding the application and the application information table, a storage for storing the application decoded by the data decoder and a controller controlling an upgrade of the application stored in the storage to be executed by tuning a channel carrying upgrade data according to data information decoded from the application information table.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the implementations and are incorporated in and constitute a part of this disclosure, illustrate implementation(s) and together with the description serve to explain the implementation(s). In the drawings;

FIG. 1 is a block diagram of a broadcast receiver capable of receiving a data broadcast application according to one embodiment of the present invention;

FIG. 2 is a table of examples of upgrade associated information fields of an application information table for a random execution management application and a random unbound application;

FIG. 3 is a diagram to explain a broadcast signal received by being segmented;

FIG. 4 is a flowchart of a method of upgrading an execution management application, i.e., a monitor application according to an embodiment of the present invention;

FIG. 5 is a flowchart of a method of upgrading an execution management application, i.e., a monitor application according to another embodiment of the present invention;

FIG. 6 and FIG. 7 are flowcharts of a method of upgrading a general unbound application; and

FIG. 8 is a block diagram of a whole broadcast system according to the present invention.

### DETAILED DESCRIPTION OF THE INVENTION

Reference will now be made in detail to the implementations, examples of which are illustrated in the accompanying drawings. Wherever possible, the same reference numbers will be used throughout the drawings to refer to the same or like parts.

First of all, applications can be categorized into bound applications and unbound application.

The bound application is an application associated with A/V streams and means an application that is not usable by a user in case of tuning a currently viewed specific channel to another channel. The bound application is the application associated with an A/V stream of a channel currently selected by a tuner. The bound application is displayed in a manner that signals are continuously received from a broadcasting station. Since the bound application is stored in a temporary storage unit instead of being permanently or semi-permanently stored in a broadcast receiver, it is deleted in case of tuning a specific channel into another channel.

On the other hand, the unbound application is an application not associated with a specific A/V channel. The unbound application means an application usable by a user if a currently viewed specific channel is tuned to another channel or even if a power of the broadcast receiver is turned on/off. The unbound application is permanently or semi-permanently stored in a broadcast receiver. Since the stored application is used, the stored application needs to be periodically updated as time goes by. The unbound application means a specific unbound application supported by a data broadcasting platform and is simply named the unbound application.

As mentioned in the foregoing description, if time goes by after completion of storing the unbound application, the stored unbound application needs an upgrade. If the application upgrade is in progress in the course of displaying a broadcast, a currently viewed broadcast signal needs to be separately processed.

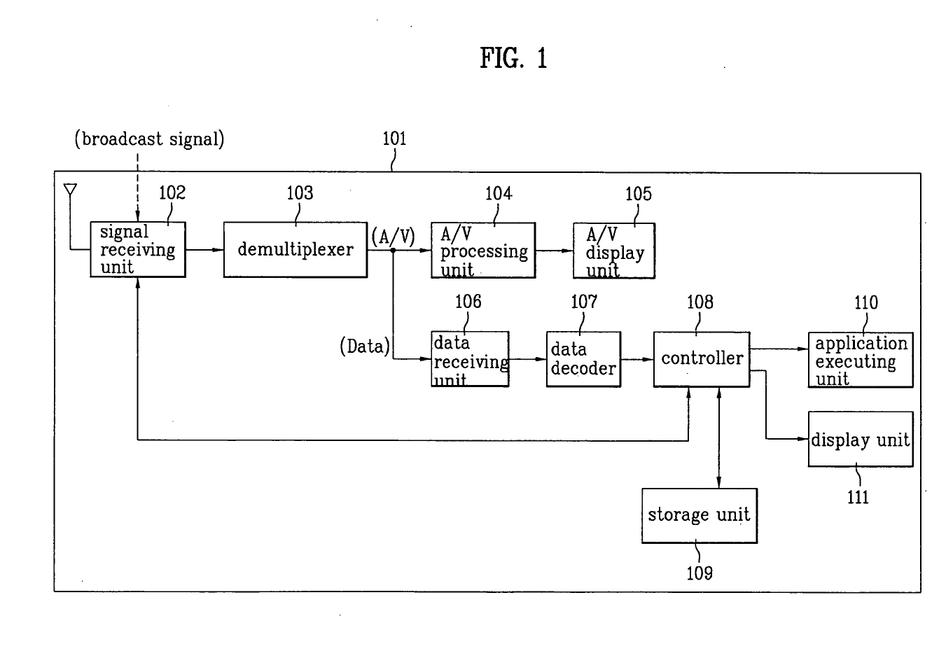

FIG. 1 is a block diagram of a broadcast receiver capable of receiving a data broadcast application according to one embodiment of the present invention.

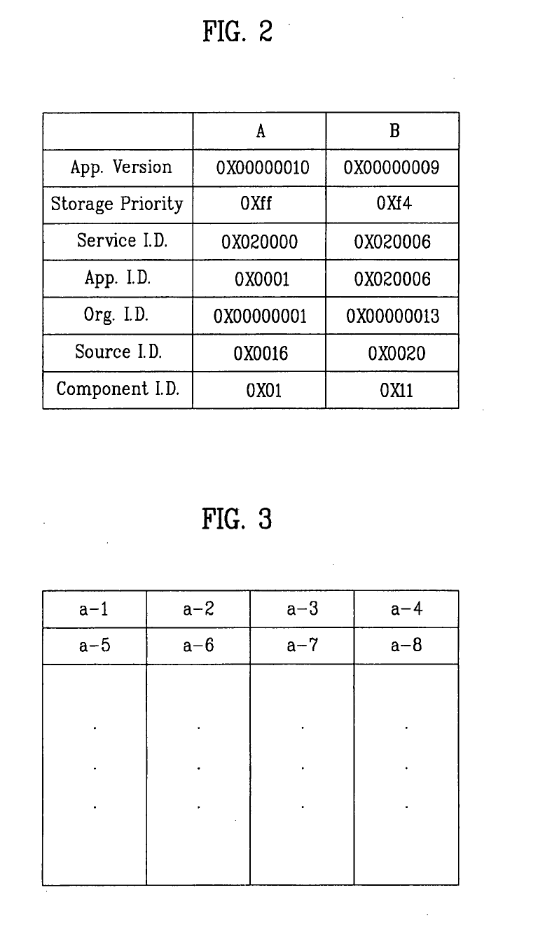

FIG. 2 is a table of examples of upgrade associated information fields of an application information table for a random execution management application and a random unbound application. A range of a value of an upgrade information field varies according to a supported data broadcasting platform. The present invention is applicable to various data broadcasting platforms. In the following description, for convenience of explanation, OCAP (open cable application platform) data broadcasting is taken as an example of a data broadcasting platform.

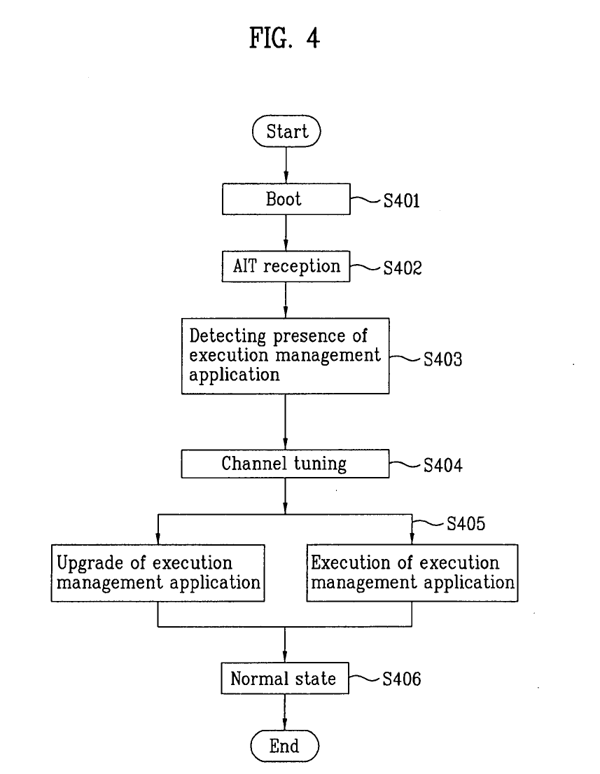

And, FIG. 3 is a diagram to explain a broadcast signal received by being segmented.

A method of receiving, storing and upgrading an execution management application of a data broadcast or an unbound application in a broadcast receiver according to the present invention is explained with reference to FIGS. 1 to 3 as follows.

In this case, the execution management application is an application for managing execution of a whole application. In a broad sense, the execution management application can be included in the unbound application. Yet, the execution management application is explained separate from a general application and named a monitor application for convenience of explanation.

In the present invention, upgrade information is defined to mean the information to receive upgrade data and the upgrade data is defined to substantially mean data for upgrading an application or an upgraded application.

Referring to FIG. 1, a broadcast receiver 101 according to the present invention includes a tuner 102, a demultiplexer 103, an A/V processing unit 104, an A/V display unit 105, a data receiving unit 106, a data decoder 107, a controller 108, a storage unit 109, an application executing unit 110, and a display unit 111.

The broadcast receiver 101 may correspond to one of a digital television (DTV) capable of data broadcasting reception, a set-top box, a host of a cable broadcast receiver, and the like. This is just an example and can be generalized into a data broadcast receivable device.

The tuner 102 receives a broadcast signal transmitted by a broadcasting station. In this case, the broadcast signal includes an A/V signal and a data broadcast signal. For instance, the tuner 102 is capable of receiving a cable broadcast signal transmitted by a cable system operator (SO), a multiple system operator (MSO), or the like.

And, the tuner 102 includes at least one or more tuners. In particular, there can exist a plurality of tuners.

The demultiplexer 103 separates the broadcast signal into the A/V broadcast signal and the data broadcast signal. The demultiplexer 103 then transfers the A/V broadcast signal to the A/V processing unit 104 and also transmits the data broadcast signal to the data receiving unit 106.

The A/V processing unit 104 carries out a process for decoding and the like to enable the received A/V signal to be outputted via the A/V display unit 105.

The A/V display unit 105 then outputs the decoded A/V broadcast signal or the like. In this case, the A/V display unit 105 can include a speaker, a screen of the broadcast receiver, and the like for example.

The data receiving unit 106 performs processing such as header removal and the like on the data broadcast signal transferred from the demultiplexer 103 and then transfers the processed signal to the data decoder 107.

Yet, the data broadcast signal transferred to the data receiving unit 106 is formatted in a manner of being normally segmented into a plurality of data, which are shown in FIG. 3. This is because the broadcasting station or the like is unable to transport a whole file once. Yet, this is just exemplary. Alternatively, whole data can be transferred as well.

The data decoder 107 decodes the data broadcast signal transferred form the data receiving unit 106 and converts the format of a plurality of the segmented data to a single complete file. In doing so, the data decoder 107 obtains information in a manner of parsing the received application information table by parsing each information field of the application information table.

The controller 108 controls the storage unit 109, the application executing unit 110, the display unit 111, the tuner 102, and the like. In particular, the controller 108 controls the data broadcast signal transferred from the data decoding unit 107 to be stored in the storage unit 109 and also controls it to be upgraded. And, the controller 108 controls the tuner 102 in association with an upgrade of the stored application.

The application executing unit 110 plays a role in executing various applications under the control of the controller 108. For instance, the applications include data broadcasts associated with games, advertisements, ordering pictures, and the like.

The display unit 111 plays a role in displaying various kinds of information necessary for users under the control of the control unit 108.

The storage unit 109 stores various applications under the control of the control unit 108. The storage unit 109 includes a semi-permanent memory such as a flash memory, a semi-perpetual memory and the like the like instead of a temporary memory. So, the present invention targets the applications stored in the storage unit. For examples, the present invention targets an unbound application independently executed without being associated with an A/V stream and a monitor application for managing an execution of an application.

For the present invention, the functions or roles of the controller 108, the storage unit 109 and the tuner 102 are explained in detail as follows.

First of all, the controller 108 controls an upgrade of an application overall based on upgrade information in an application information table. Type, usage and field size of upgrade information are explained as follows. In FIG. 2, ‘A’ indicates a monitor application and ‘B’ indicates a general unbound application. And, a value of field is set to an arbitrary value.

First of all, an application version field (App. Version) indicates a version of application. The controller compares a version of an application stored in the storage unit to a version of received application information. So, if the version of the received upgrade information is higher than that of the stored application, it can be decided to execute an upgrade. In this case, a size the application version field is 32-bit.

A storage priority field (Storage Priority) indicates a storage priority of an application to be stored in the storage unit. This field is 8-bit. If this field is set to 0xff, i.e., if it is set to 255, it is recognized as a monitor application. If it is set to a value lower than 255, it indicates a general unbound application.

A service ID field (Service I.D.) has a 24-bit length and indicates a type of service.

An organization ID field (Org. I.D.) has a 32-bit length and identifies an application by identifying a transmitting side of an application.

An application ID field (App. I.D.) has a 16-bit length and identifies an individual application. And, the application ID has a unique value of an individual application.

A source ID (Source I.D.) indicates a channel that carries data. The source ID field is 16-bit. So, it is able to recognize a channel carrying upgrade information using the source ID field. In case that a channel carrying upgrade information is different from a currently viewed channel, the controller controls the tuner to perform tuning on a separate channel.

And, a component ID field (Component I.D.) indicates a stream having data loaded therein. The component ID field is 8-bit. Even if channels are same, it is able to know a correct stream using the component ID field. This facilitates upgrade data to be received.

In brief, an application to be upgraded can be recognized using the storage priority field, the service ID field, the application ID field and the organization ID field. Whether to perform an upgrade is decided using the application version field. And, a channel carrying upgrade data can be recognized using the source ID field and the component ID field.

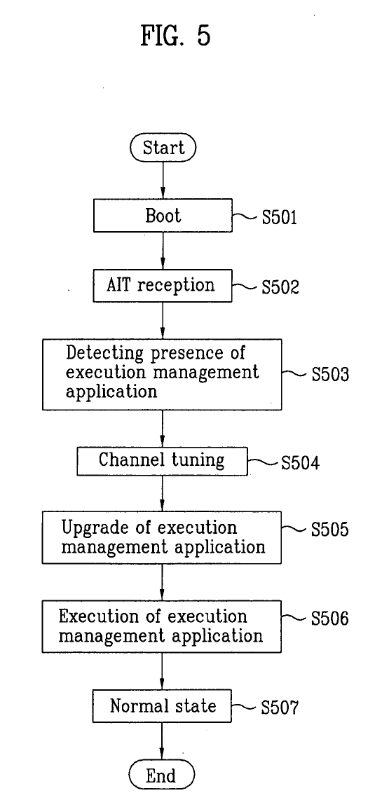

FIG. 4 is a flowchart of a method of upgrading an execution management application, i.e., a monitor application according to an embodiment of the present invention.

Referring to FIG. 4, a system is booted (S401). An application information table is received (S402). Application information is then obtained by parsing the received application information table.

According to the obtained application information, a presence or non-presence of an execution management application is detected (S403). A channel is tuned (S404). Both an upgrade of the execution management application and an application are then executed (S405).

After completion of the upgrade of the application, the system goes back to a normal state (S406).

In the above steps, the aforesaid explanation is applied to the reception and parsing of the application information table and the application upgrade associated information fields.

The channel tuning and the upgrade and execution of application of the present invention are explained in detail as follows.

First of all, if a presence of the execution management application is detected and if an application needs to be upgraded, an upgrade procedure is initiated.

In case that a channel carrying upgrade data is an out-of-band (OOB), the OOB channel is always open regardless of an in-band channel for receiving a broadcast signal. So, it is facilitated to receive the upgrade data. And, it is also facilitated to transmit upgrade data using a network.

Yet, in case that upgrade data is carried by an in-band channel, a specification of a current data broadcast has a problem in association with channel tuning for an upgrade of an application.

When a current broadcast is viewed, if upgrade data is transmitted on a channel different from a currently viewed channel, an upgrade data channel should be newly tuned. Of course, if upgrade data is transmitted via the same channel of the currently viewed channel, the separate channel tuning is unnecessary.

An upgrade information table is received via an OOB channel, a network or a currently viewed broadcast channel. By parsing the upgrade information table, a presence o non-presence of an upgrade is recognized and upgrade associated information is obtained as well. The upgrade information table can be represented as an application information table as well. The application information table includes AIT. If a data broadcasting platform is OCAP (open cable application platform), the application information table includes AIT or XAIT. In case that the application information table is transmitted on OOB, the data broadcasting platform includes the XAIT. So, if the upgrade information table, i.e., the application information table is XAIT, it means that the application information table is transmitted via OOB. IN the accompanied drawings, the description of ‘XAIT reception’ is just exemplary, which does not restrict a scope of the present invention.

From the upgrade information, an application to be upgraded and an upgrade data channel are recognized. If a currently viewed channel and an upgrade channel differ from each other, the upgrade data channel for receiving upgrade data is tuned. In particular, while a broadcast signal is received, if it is detected that upgrade data is received via a different channel, it is controlled to receive the upgrade data by tuning an upgrade channel.

In doing so, it is able to tune an application upgrade data channel using a tuner for tuning a broadcast signal channel. In this case, since a currently viewed channel stops being tuned, it is unable to view a broadcast in case of tuning an upgrade data channel.

To solve this problem, it is able to tune a separate channel using a tuner different from a tuner for tuning a currently viewed channel. If so, as a current channel keeps being tuned, a viewer is able to keep viewing a corresponding broadcast conveniently.

The present invention proposes both of the above two embodiments.

After completion of tuning a channel, an application is substantially upgraded and executed. In this case, by completing data segments transmitted on a channel, the upgrade and execution can be carried out regardless of a temporal sequence. In particular, even if an execution management application is being received, an upgraded application is executable. As mentioned in the foregoing description of FIG. 3, since the upgrade data is received as data segments, an application can be executed in the course of receiving upgrade data in a manner of having the upgrade proceed by a upgrade segment unit.

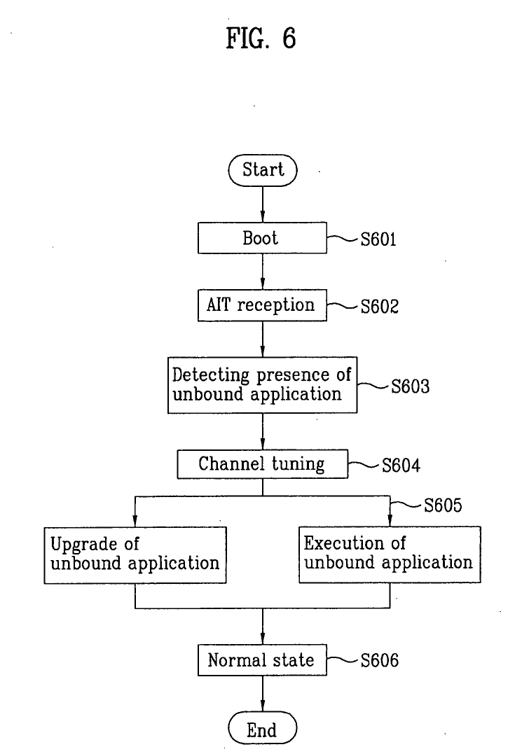

FIG. 5 is a flowchart of a method of upgrading an execution management application, i.e., a monitor application according to another embodiment of the present invention.

Referring to FIG. 5, steps of detecting a presence of an execution management application and tuning a channel in a method of upgrading an execution management application, i.e., a monitor application according to another embodiment of the present invention are equal to those of the former embodiment of the present invention. Yet, an upgrade step and an execution step of the current embodiment of the present invention differ from those of the former embodiment of the present invention.

In particular, the upgrade and execution of the application are carried out by the single step S405 regardless of a time sequence. Yet, in the embodiment shown in FIG. 5, the upgrade of application and the execution of application are carried out in separate steps, respectively. So, after an execution management application has been upgraded (S505), the upgraded execution management application is executed (S506). In other words, after completion of the upgrade of the application, the upgraded application is executed.

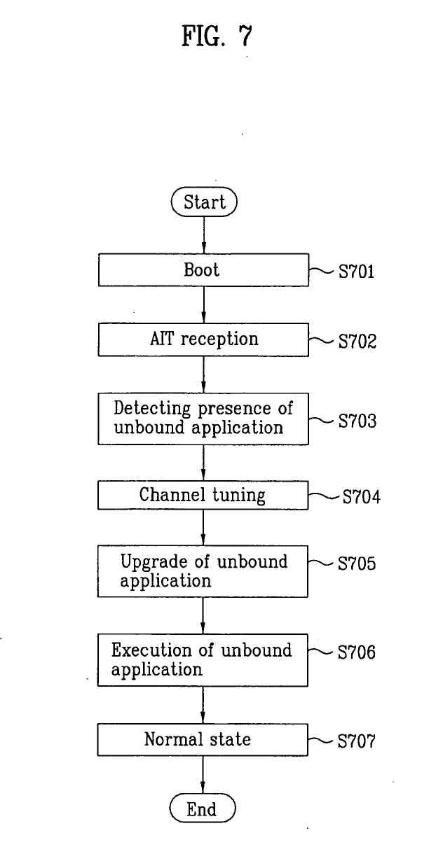

FIG. 6 and FIG. 7 are flowcharts of a method of upgrading a general unbound application.

The descriptions for the embodiments shown in FIG. 4 and FIG. 5 are applied to the embodiments shown in FIG. 6 and FIG. 7, respectively.

In particular, the description for the embodiment shown in FIG. 4 is applied to the embodiment shown in FIG. 6 and the description for the embodiment shown in FIG. 5 is applied to the embodiment shown in FIG. 7. In this case, the execution management application is replaced by an unbound application.

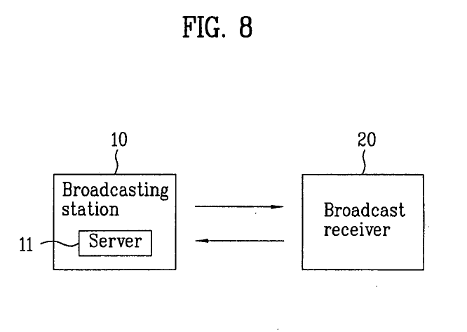

FIG. 8 is a block diagram of a whole broadcast system according to the present invention.

Referring to FIG. 8, a broadcast system according to the present invention includes a broadcasting station 10 and a broadcast receiver 20. The broadcasting station 10 includes a server 11.

The broadcasting station 11 transmits data associated with an upgrade to the broadcast receiver 20. In this case, the data is stored in the server 11 of the broadcasting station 10. The application associated information stored in the server 11 is transmitted by data transmitting scheme such as carousel and the like. The carousel means a method of repeatedly transmitting data to effectively use a downlink channel having a bandwidth relatively greater than that of an uplink channel in digital video broadcasting. The carousel is exemplarily proposed and does not restrict the scope of embodiment of the present invention.

Accordingly, the present invention provides the following effects or advantages.

First of all, an application can be smoothly upgraded by controlling channel tuning while upgrade data is transmitted on a channel different from a currently viewed channel. In particular, in case that upgrade data is transmitted on an in-band channel, it can be received by tuning an application upgrade channel in the course of receiving a currently broadcast signal.

Secondly, an application can be upgraded without interrupting to display a currently viewed channel in case of using a plurality of tuners.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of controlling a data broadcast application, comprising the steps of:
receiving an application information table supported by a data broadcasting platform;
extracting an application upgrade information by parsing the application information table;
tuning a channel carrying upgrade data according to the extracted application upgrade information; and
executing an application upgrade by receiving the upgrade data via the tuned channel.

2. The method of claim 1, wherein the application information table comprises AIT.

3. The method of claim 1, wherein the data broadcasting platform is for OCAP (open cable application platform) data broadcasting and wherein the application information table comprises XAIT.

4. The method of claim 1, wherein the application comprises either an unbound application or an execution management application.

5. The method of claim 1, wherein the channel carrying the update data is an in-band channel.

6. The method of claim 5, further comprising the steps of:
deciding whether the channel carrying the upgrade data is equal to a currently viewed channel; and
if the channel carrying the upgrade data is not equal to the currently viewed channel, tuning the channel carrying the upgrade data.

7. The method of claim 1, wherein the upgrade information comprises at least one selected from the group consisting of an application version, a storage priority, a service ID, an application ID, an organization ID, a source ID, and a component ID.

8. The method of claim 7, wherein whether to execute the application upgrade is decided based on the application version information.

9. The method of claim 7, wherein an application needing to be upgraded is identified using at least one information selected from the group consisting of the storage priority, the service ID, the application ID, and the organization ID.

10. The method of claim 7, wherein the channel carrying the upgrade data is identified and tuned using either the source ID or the component ID.

11. The method of claim 1, further comprising the step of after completion of upgrading the application, executing the upgraded application sequentially.

12. A broadcast receiver for receiving a data broadcast application, comprising:
a signal receiving unit receiving and tuning a channel including an application supported by a data broadcasting platform and an application information table;
a data decoder decoding the application and the application information table;
a storage for storing the application decoded by the data decoder; and
a controller controlling an upgrade of the application stored in the storage to be executed by tuning a channel carrying upgrade data according to data information decoded from the application information table.

13. The broadcast receiver of claim 12, wherein the signal receiving unit comprises at least two tuners and wherein the channel carrying the upgrade data is tuned by the tuner not used in tuning a currently viewed channel.

14. The broadcast receiver of claim 12, wherein the channel carrying the upgrade data is an in-band channel.

15. The broadcast receiver of claim 12, wherein the data decoder extracts application information data information by parsing the application information table.

16. The broadcast receiver of claim 12, wherein the upgrade information comprises at least one selected from the group consisting of an application version, a storage priority, a service ID, an application ID, an organization ID, a source ID, and a component ID.

17. The broadcast receiver of claim 12, wherein a presence or non-presence of an upgrade is decided based on the application version information.

18. The broadcast receiver of claim 12, wherein an application needing to be upgraded is identified using at least one information selected from the group consisting of the storage priority, the service ID, the application ID, and the organization ID.

19. The broadcast receiver of claim 12, wherein the channel carrying the upgrade data is identified and tuned using either the source ID or the component ID.

20. The broadcast receiver of claim 12, wherein the application comprises either an unbound application or an execution management application.

21. The broadcast receiver of claim 12, wherein the control unit decides whether the channel carrying the upgrade data is equal to a currently viewed channel and then controls the tuning unit, if the channel carrying the upgrade data is not equal to the currently viewed channel, to tune the channel carrying the upgrade data.

22. The broadcast receiver of claim 12, further comprising an application executing unit, if the upgrade of the application stored in the storage is completed, executing the upgraded application.
